(19) United States
(12) Patent Application Publication
(10) Pub. No.: US 2009/0114527 A1
(43) Pub. Date: May 7, 2009

(54) METHOD FOR PREPARING ELECTRODE MATERIAL FOR BATTERY

(75) Inventors: Bing-Joe Hwang, Taipei City (TW); Shao-Kang Hu, Taichung City (TW); Tzu-Hung Yu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei City (TW)

(21) Appl. No.: 12/032,691

(22) Filed: Feb. 17, 2008

(30) Foreign Application Priority Data
Nov. 5, 2007 (TW) 96141664

(51) Int. Cl. B01J 19/12

(52) U.S. Cl. 204/157.43

(57) ABSTRACT

A method for preparing an electrode material for battery is provided. The method includes the following steps: firstly, providing a reaction precursor having a crystal structure, in which the reaction precursor represents as NaₓM_{y}M′_{z}O₂, and M and M′ are not the same metal; next, dispersing the reaction precursor in a solvent, and adding a lithium (Li) salt therein, so as to form a mixed solution; and then, performing a microwave heating treatment on the mixed solution, in which Li⁺ in the Li salt are ion exchanged with Na⁺ in the reaction precursor, so as to form LiₓM_{y}M′_{z}O₂ as the electrode material.

### CROSS-REFERENCE TO RELATED APPLICATION

This application claims the priority benefit of Taiwan application serial no. 96141664, filed on Nov. 5, 2007. The entirety of the above-mentioned patent application is hereby incorporated by reference herein and made a part of this specification.

### BACKGROUND OF THE INVENTION

1. Field of the Invention

The present invention relates to a method for preparing a metal oxide material, and more particularly to a method for preparing an electrode material for battery.

2. Description of Related Art

As the rapid progress of technology, the consumption of traditional energy resources, such as coal, crude oil and natural gas, is continuously increased. As the storage of the natural energy resources is rather limited, many countries all over world are continuously researching and developing new alternative energy resources to replace the traditional energy resources, in which battery is an important solution with high practical value.

Especially, in the current electronic information era, the demands for batteries have been rapidly increased. At the current development stage of batteries, not only the breakthroughs are required to be made in terms of the battery design and battery-manufacturing technology, but the requirements for the electrode material for battery also become increasingly high. Generally, if the electrode material has poor structural properties, the performance of the battery may be influenced. Furthermore, as known from the conventional references that, even if the chemical compositions for the electrode materials are the same, the properties thereof may be significantly changed, due to the differences in the preparation processes. Therefore, how to develop a novel preparation method for preparing a high-performance electrode material is an important issue for the researches made in battery relevant fields.

Furthermore, some patents have already disclosed relevant techniques about electrode materials and preparation method thereof, for example, US 2006/0147365A1, US 2005/0069484A1, JP 2002134115A2, and EP 1553647A1, which are incorporated into the present invention as references.

### SUMMARY OF THE INVENTION

Accordingly, the present invention is directed to a method for preparing an electrode material for battery, which is capable of reducing the time spent on preparing the material, effectively eliminating an ion mixing phenomenon, and improving the structural stability of the material.

As embodied and broadly described herein, the present invention provides a method for preparing an electrode material for battery. The method includes the following steps: first, providing a reaction precursor having a crystal structure, in which the reaction precursor is represented as NaₓM_{y}M′_{z}O₂, and M, M′ are not the same metal; next, dispersing the reaction precursor in a solvent, and adding a lithium (Li) salt, so as to form a mixed solution; then, performing a microwave heating treatment on the mixed solution, in which Li⁺ in the lithium salt are ion exchanged with Na⁺ in the reaction precursor, so as to form LiₓM_{y}M′_{z}O₂ as an electrode material.

In the method for preparing the electrode material for battery according to an embodiment of the present invention, M is iron, cobalt, nickel, manganese, vanadium, chromium, or aluminum.

In the method for preparing the electrode material for battery according to an embodiment of the present invention, M′ is iron, cobalt, nickel, manganese, vanadium, chromium, or aluminum.

In the method for preparing the electrode material for battery according to an embodiment of the present invention, the electrode material is LiₓM_{y}M′_{z}O₂, in which 0.01<x≦1, 0.01<z<1, y=1−z.

In the method for preparing the electrode material for battery according to an embodiment of the present invention, the electrode material is LiₓM_{y}M′_{z}O₂, in which 0.01<x≦1, 0.01<z<2, y=2−z.

In the method for preparing the electrode material for battery according to an embodiment of the present invention, the temperature for the microwave heating treatment is between 60° C. and 200° C.

In the method for preparing the electrode material for battery according to an embodiment of the present invention, the time duration for the microwave heating treatment is from 3 min to 240 min.

In the method for preparing the electrode material for battery according to an embodiment of the present invention, the solvent is an organic or inorganic solvent capable of dissolving the Li salt.

In the method for preparing the electrode material for battery according to an embodiment of the present invention, the lithium salt is lithium bromide or lithium chloride.

In the method for preparing the electrode material for battery according to an embodiment of the present invention, the concentration ratio (Na/Li) of Na⁺ in the reaction precursor to Li⁺ in the electrode material is 2-20.

In the method for preparing the electrode material for battery according to an embodiment of the present invention, the concentration ratio (Na/Li) of Na⁺ in the reaction precursor to Li⁺ in the electrode material is 2-8.

In the method for preparing the electrode material for battery according to an embodiment of the present invention, the microwave frequency for the microwave heating treatment is between 300 MHz and 300 GHz.

In the method for preparing the electrode material for battery according to an embodiment of the present invention, the microwave power for the microwave heating treatment is between 1 W and 500 W.

In the method for preparing the electrode material for battery according to an embodiment of the present invention, the microwave power for the microwave heating treatment is 100 W.

In the method for preparing the electrode material for battery according to an embodiment of the present invention, the process for preparing the reaction precursor is, for example, a sol-gel process or a solid-state sintering process.

In the method for preparing the electrode material for battery according to an embodiment of the present invention, the electrode material for battery has a laminate crystal structure, a spinel crystal structure, or an olivine crystal structure.

In the method for preparing the electrode material for battery according to an embodiment of the present invention, the electrode material for battery is applicable for fuel cells or lithium-ion batteries.

The method for preparing the electrode material for battery in the present invention utilizes a microwave heating treatment to perform ion exchange, so as to prepare an electrode material. Compared with the methods in the conventional art, the method of the present invention is much simpler and requires a shorter time for the preparation process. Furthermore, the method of the present invention is capable of improving the structural stability of the electrode material and enhancing the performance of the battery.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a method for preparing an electrode material for battery according to an embodiment of the present invention.

FIG. 2 shows an XRD pattern of NaNi_{0.5}Mn_{0.5}O₂ prepared by a sol-gel process and JCPDS standard patterns of NaNiO₂ and NaMnO₂.

FIG. 3 shows an XRD pattern of LiNi_{0.5}Mn_{0.5}O₂ formed by performing a microwave-ion exchange process for many times to the NaNi_{0.5}Mn_{0.5}O₂ prepared by the sol-gel process.

FIG. 4 shows an XRD pattern of LiNi_{0.5}Mn_{0.5}O₂ prepared by a microwave-ion exchange process.

FIG. 5 shows a diagram of a capacity for charge-discharge cycles to a cycle number for a battery with LiNi_{0.5}Mn_{0.5}O₂ prepared according to the present invention as a cathode plate.

### DESCRIPTION OF EMBODIMENTS

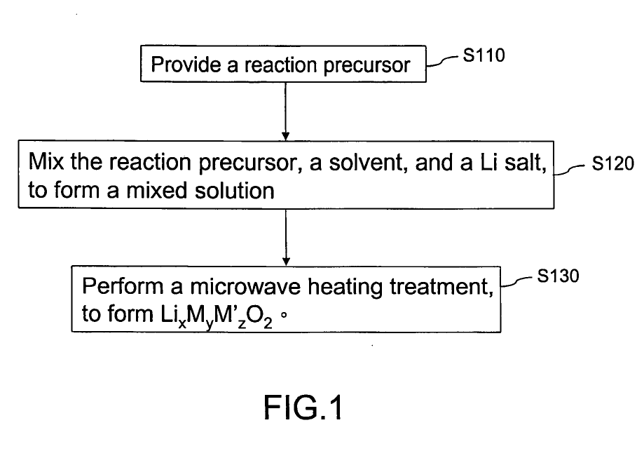

FIG. 1 is a flow chart of a method for preparing an electrode material for battery according to an embodiment of the present invention.

Referring to FIG. 1, firstly, in Step S110, a reaction precursor is provided. The reaction precursor has a crystal structure and a chemical formula of NaₓM_{y}M′_{z}O₂, wherein M and M′ are not the same metal. M and M′ may be independently iron (Fe), cobalt (Co), nickel (Ni), manganese (Mn), vanadium (Va), chromium (Cr), or aluminum (Al). In an embodiment, the reaction precursor is prepared by, for example, a sol-gel process, a solid-state sintering process, or other suitable process. The above processes for preparing the reaction precursor are well known to those of ordinary skills in the art and will not be repeated herein.

Next, in Step S120, the reaction precursor, a solvent, and a lithium (Li) salt are mixed to form a mixed solution. Particularly, the reaction precursor is dispersed in a solvent, and the Li salt is added therein, so as to form the mixed solution. The solvent used is an organic or inorganic solvent capable of dissolving the Li salt. The Li salt is lithium bromide, lithium chloride, or other suitable Li salts. In an embodiment, the solvent is, for example, n-hexanol, and the Li salt is, for example, lithium bromide.

Referring to FIG. 1 again, in Step S130, a microwave heating treatment is performed on the mixed solution, so as to form LiₓM_{y}M′_{z}O₂. Particularly, when the microwave heating treatment is performed on the mixed solution, Li⁺ in the Li salt are ion exchanged with Na⁺ in the reaction precursor, so as to form LiₓM_{y}M′_{z}O₂. The concentration ratio (Na/Li) of Na⁺ in the reaction precursor to Li⁺ in the electrode material is 2-20, and preferably 2-8. Furthermore, the prepared LiₓM_{y}M′_{z}O₂ may serve as an electrode material, in which 0.01<x≦1, 0.01<z<1, y=1−z. Furthermore, x, y, and z may also satisfy the following conditions: 0.01<x≦1, 0.01<z<2, y=2−z.

Accordingly, the conditions for the microwave heating treatment performed in Step S130 are listed as follows. The temperature for the microwave heating treatment is between 60° C. and 200° C.; the time duration for the microwave heating treatment is between 3 min and 240 min; the microwave frequency for the microwave heating treatment is between 300 MHz and 300 GHz; and the microwave power for the microwave heating treatment is between 1 W and 500 W, and preferably 100 W. It should be noted that, the ion exchange in the conventional art is generally performed through the water-jacket heating to form an electrode material, which always takes tens of hours.

Furthermore, LiₓM_{y}M′_{z}O₂ prepared by the method of the embodiment may have a laminate crystal structure, a spinel crystal structure, or an olivine crystal structure. LiₓM_{y}M′_{z}O₂ may serve as the electrode material for fuel cells, lithium-ion batteries, or other suitable batteries.

It should be particularly stated that, as the method for preparing the electrode material of the present invention utilizes a microwave heating treatment to perform ion exchange so as to form LiₓM_{y}M′_{z}O₂, not only the time duration for the manufacturing process is shortened, the preparation efficiency is improved, but the ion mixing phenomenon in LiₓM_{y}M′_{z}O₂ is also effectively eliminated, and thus the structural stability of the material is improved.

Hereinafter, the method for preparing the electrode material of the present invention is illustrated and the material characteristic analysis is made below in detail through the following embodiments. Hereinafter, in LiₓM_{y}M′_{z}O₂, M is nickel, M′ is manganese, x=1, y=0.5, and z=0.5, i.e., the preparation of LiNi_{0.5}Mn_{0.5}O₂ is taken as an example for illustration below.

### EXPERIMENTAL EXAMPLE

### Preparation of LiNi_{0.5}Mn_{0.5}O₂

First, NaNi_{0.5}Mn_{0.5}O₂ (the precursor of LiNi_{0.5}Mn_{0.5}O₂) having a crystal structure is prepared by a sol-gel process.

The process for preparing NaNi_{0.5}Mn_{0.5}O₂ includes the following steps, for example, firstly, a sodium salt, a nickel salt, and a manganese salt are weighted according to a proper molar ratio, and deionized water is added, so as to get a saturated ion solution. Next, a saturated solution of citric acid (at the molar ratio of cation:citric acid=1:1) is formulated. Thereafter, the saturated solution of citric acid is slowly dropped into the saturated ion solution, and then the pH value of the mixed solution is adjusted to 7-12 by aqueous ammonia, and the mixed solution is heated to 80° C., to remove the excess moisture, so as to form a high-viscosity gel. Then, the gel is moved into an oven and dried for 10-12 hr, to get a powder compound. Then, the powder compound is calcined at different temperatures with an appropriate heating/cooling rate, to get a crystalline powder of NaNi_{0.5}Mn_{0.5}O₂, i.e., the precursor of LiNi_{0.5}Mn_{0.5}O₂.

Then, after getting the crystalline powder of NaNi_{0.5}Mn_{0.5}O₂, the crystalline powder of NaNi_{0.5}Mn_{0.5}O₂ is then dispersed in n-hexanol, and 2-10 doses of a solution of lithium bromide is added therein, to get a mixed solution.

Thereafter, a microwave heating treatment is performed on the mixed solution at a heating temperature of about 60° C.-200° C. for about 3 min to 240 min, so that Li⁺ are ion exchanged with Na⁺, so as to form LiNi_{0.5}Mn_{0.5}O₂.

### [Material Structural Analysis]

Hereinafter, LiNi_{0.5}Mn_{0.5}O₂ prepared by the method of the present invention is evaluated. The material structural analysis is further performed through using an X-ray diffractometer (XRD).

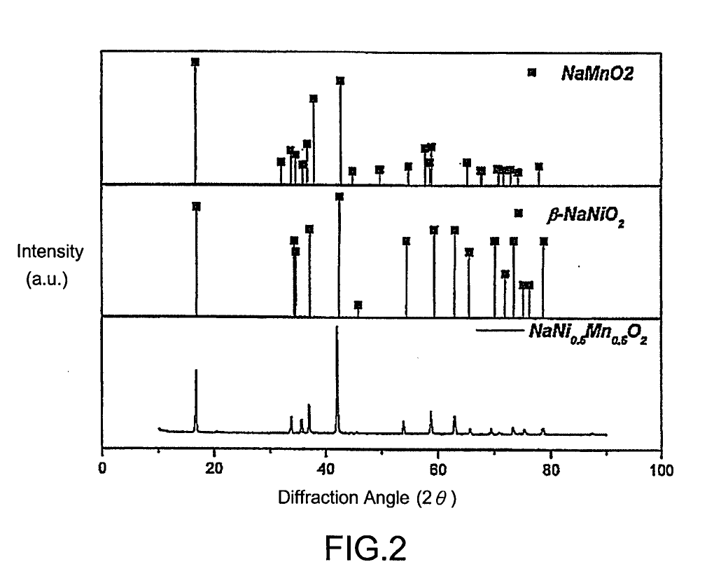

Referring to FIG. 2, it shows an XRD pattern of NaNi_{0.5}Mn_{0.5}O₂ prepared by a sol-gel process and JCPDS standard patterns of NaNiO₂ and NaMnO₂.

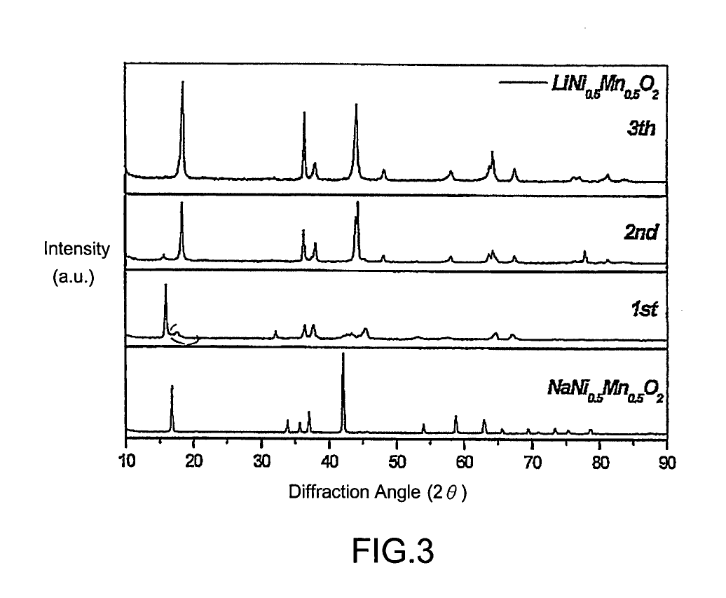

Referring to FIG. 3, it shows an XRD pattern of LiNi_{0.5}Mn_{0.5}O₂ formed by performing a microwave-ion exchange process for many times to the NaNi_{0.5}Mn_{0.5}O₂ prepared by the sol-gel process. It can be seen from FIG. 3 that, the crystal structure of NaNi_{0.5}Mn_{0.5}O₂ changes with the times for performing the microwave-ion exchange process. After the microwave-ion exchange process, Na⁺ in the crystal structure of NaNi_{0.5}Mn_{0.5}O₂ are gradually replaced by Li⁺, and the laminate characteristics of NaNi_{0.5}Mn_{0.5}O₂ are maintained.

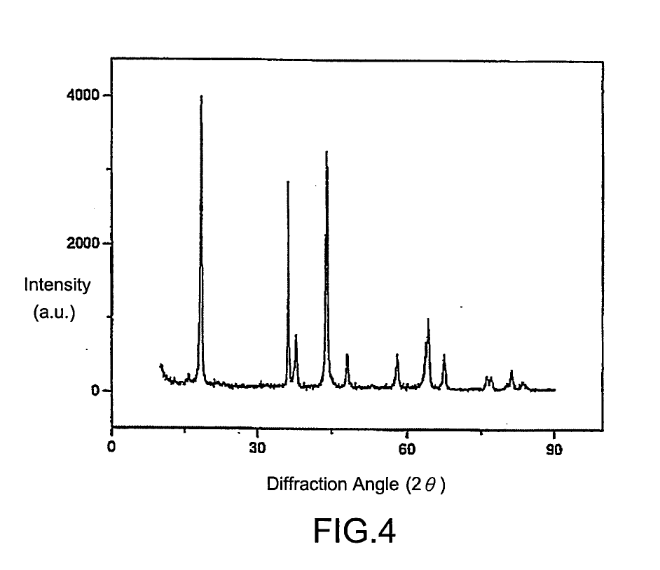

Referring to FIG. 4, it shows an XRD pattern of LiNi_{0.5}Mn_{0.5}O₂ prepared by a microwave-ion exchange process. It can be found from FIG. 4 that, LiNi_{0.5}Mn_{0.5}O₂ prepared by the method of the present invention can maintain desired laminate structure and has no serious ion mixing phenomenon.

### [Test of Electrochemical Properties]

In order to fully understand the application of the electrode material prepared by the method of the present invention in batteries, LiNi_{0.5}Mn_{0.5}O₂ prepared by the microwave-ion exchange process is made into a cathode plate and packed into a button cell in a glove box, for performing a charge-discharge test.

The process for making LiNi_{0.5}Mn_{0.5}O₂ into a cathode plate is illustrated as follows. First, LiNi_{0.5}Mn_{0.5}O₂ is placed into the glove box to be balanced for 24 hr. Next, LiNi_{0.5}Mn_{0.5}O₂, carbon black, and polyvinylidene fluoride (PVDF) are weighted at a weight ratio of 80%, 10%, and 10%. Then, LiNi_{0.5}Mn_{0.5}O₂ of 80% and the carbon black of 10% are placed into a sample bottle A, and mixed by a 3-D mixer for 2 hr, and then PVDF of 10% is placed into a sample bottle B, and then an appropriate amount of N-methyl-2-pyrrolidone (NMP) is added as a solvent, and then stirred for 2 hr. Thereafter, a stainless steel plate is placed into an oven and pre-heated at 120° C. Then, the mixed powder in the sample bottle A is taken out and placed into the sample bottle B, two agate beads are placed into the sample bottle B, and the mixture is stirred at a constant rate (250 rpm), so as to get a uniformly mixed slurry. Meanwhile, an aluminum foil is cut into small pieces with a property size and washed with 1N NaOH solution (10 g of NaOH dissolved in 250 ml of deionized water) for 1 min, then cleaned with deionized water, and then immersed in ethanol. Thereafter, the pre-heated stainless steel plate is taken out and wiped with alcohol, and the aluminum foil is flatly attached on the stainless steel plate. Then, the uniformly mixed slurry is coated on the aluminum foil. Afterwards, the whole stainless steel plate is placed into an oven and dried to remove the solvent. Then, the aluminum foil is mangled by a mangling machine with a proper mangling thickness (100-150 mm) for several times, and then cut into a cathode plate with a diameter of about 1.3 cm by a cutting machine.

Next, after finishing the manufacturing of the cathode plate, a button cell is packed in the glove box.

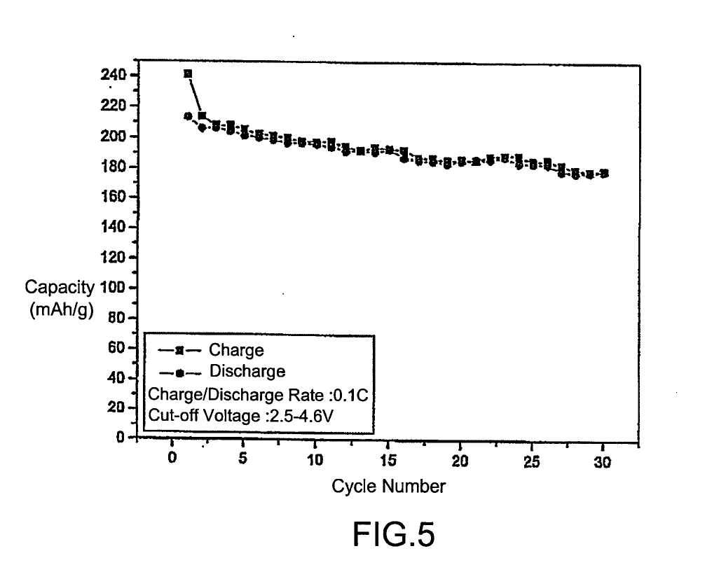

Referring to FIG. 5, it shows a diagram of a capacity for charge-discharge cycles to a cycle number for a battery with LiNi_{0.5}Mn_{0.5}O₂ prepared according to the present invention as a cathode plate. As shown in FIG. 5, the initial capacity is about 210 mAh/g, and thus, it can be known that the electrode material prepared by the microwave-ion exchange process of the present invention has excellent electrochemical properties.

As the present invention utilizes a microwave heating treatment to perform ion exchange, the electrode material can be formed in a short time, and thus the method of the present invention is cost-saving and convenient and is capable of improving the structural stability of the material.

To sum up, the method for preparing an electrode material for battery of the present invention not only can stabilize the structure of the electrode material, improve the performance of the battery, and prolong the life time of the battery, but it is also quite simple and capable of shortening the time for the manufacturing process and reducing the manufacturing cost, so it can be applied in industrial mass production and improve the competitiveness and occupancy in domestic market.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for preparing an electrode material for battery, comprising:
providing a reaction precursor having a crystal structure, wherein the reaction precursor is represented as NaₓM_{y}M′_{z}O₂, and M, M′ are not the same metal;
dispersing the reaction precursor in a solvent, and adding a lithium (Li) salt therein, so as to form a mixed solution; and
performing a microwave heating treatment on the mixed solution, wherein Li⁺ in the Li salt are ion exchanged with Na⁺ in the reaction precursor, so as to form LiₓM_{y}M′_{z}O₂ as the electrode material.

2. The method for preparing the electrode material for battery as claimed in claim 1, wherein M is iron, cobalt, nickel, manganese, vanadium, chromium, or aluminum.

3. The method for preparing the electrode material for battery as claimed in claim 1, wherein M′ is iron, cobalt, nickel, manganese, vanadium, chromium, or aluminum.

4. The method for preparing the electrode material for battery as claimed in claim 1, wherein the electrode material is LiₓM_{y}M′_{z}O₂, and 0.01<x≦1, 0.01<z<1, y=1−z.

5. The method for preparing the electrode material for battery as claimed in claim 1, wherein the electrode material is LiₓM_{y}M′_{z}O₂, and 0.01<x≦1, 0.01<z<2, y=2−z.

6. The method for preparing the electrode material for battery as claimed in claim 1, wherein the temperature for the microwave heating treatment is between 60° C. and 200° C.

7. The method for preparing the electrode material for battery as claimed in claim 1, wherein the time duration for the microwave heating treatment is between 3 min and 240 min.

8. The method for preparing the electrode material for battery as claimed in claim 1, wherein the solvent is an organic or inorganic solvent capable of dissolving the Li salt.

9. The method for preparing the electrode material for battery as claimed in claim 1, wherein the Li salt is lithium bromide or lithium chloride.

10. The method for preparing the electrode material for battery as claimed in claim 1, wherein the concentration ratio (Na/Li) of Na⁺ in the reaction precursor to Li⁺ in the electrode material is 2-20.

11. The method for preparing the electrode material for battery as claimed in claim 1, wherein the concentration ratio (Na/Li) of Na⁺ in the reaction precursor to Li⁺ in the electrode material is 2-8.

12. The method for preparing the electrode material for battery as claimed in claim 1, wherein a microwave frequency for the microwave heating treatment is between 300 MHz and 300 GHz.

13. The method for preparing the electrode material for battery as claimed in claim 1, wherein a microwave power for the microwave heating treatment is between 1 W and 500 W.

14. The method for preparing the electrode material for battery as claimed in claim 1, wherein the microwave power for the microwave heating treatment is 100 W.

15. The method for preparing the electrode material for battery as claimed in claim 1, wherein the process for preparing the reaction precursor comprises a sol-gel process or a solid-state sintering process.

16. The method for preparing the electrode material for battery as claimed in claim 1, wherein the electrode material for battery has a laminate crystal structure, a spinel crystal structure, or an olivine crystal structure.

17. The method for preparing the electrode material for battery as claimed in claim 1, wherein the electrode material for battery is applicable for fuel cells or lithium-ion batteries.
